(19) United States
(12) Patent Application Publication
(10) Pub. No.: US 2026/0043105 A1
(43) Pub. Date: Feb. 12, 2026

(54) Steel sheet having excellent powdering properties after press-hardening and method for manufacturing the same

(71) Applicant: ArcelorMittal, Luxembourg (LU)

(72) Inventors: Maxime BROSSARD, ARS-LAQUENEXY (FR); Tiago MACHADO AMORIM, Longeville Les Metz (FR); Jeremie JOUAN, YUTZ (FR)

(21) Appl. No.: 19/099,032

(22) PCT Filed: Aug. 1, 2023
(86) PCT No.: PCT/IB2023/057776

§ 371 Date: Jan. 27, 2025

(30) Foreign Application Priority Data
Aug. 4, 2022 (WO) PCT/IB2022/057251

(51) Int. Cl. C21D 9/48; B32B 15/01; C21D 1/673; C21D 8/04; C22C 21/10

(52) U.S. Cl. CPC C21D 9/48; B32B 15/012; C21D 1/673; C21D 8/0405; C21D 8/0421; C22C 21/10; B32B 2250/02; B32B 2311/24; B32B 2311/30; C21D 2211/002; C21D 2211/005; C21D 2211/008

(57) ABSTRACT

A coated steel sheet providing cathodic protection and suitable for manufacturing a press hardened part with good powdering resistance during press-hardening and good corrosion performance. A method for the manufacture of hardened parts starting from a steel sheet coated with a metallic coating. The part has good characteristics with respect to corrosion and powdering resistance. The present disclosure is particularly well suited for the manufacture of automotive vehicles.

The present invention relates to a method for the manufacture of hardened parts starting from a steel sheet coated with a metallic coating. The part has good characteristics with respect to corrosion and powdering resistance. The invention is particularly well suited for the manufacture of automotive vehicles.

### BACKGROUND

In recent years the use of coated steels in hot-stamping processes for the shaping of parts has become important, especially in the automotive industry. Fabrication of such parts may include the following main steps:
Coating of steel sheets, by hot dipping.
Trimming or cutting for obtaining blanks.
Heating the blanks in order to obtain alloying of the steel substrate with the coating, as well as the austenitizing of the steel.
Press hardening of the part in order to obtain a predominantly martensitic structure.

### SUMMARY OF THE INVENTION

Thanks to the diffusion of iron from the steel substrate through the coating, intermetallic alloys with high melting temperature are generated. The blanks having such coating may be heated in a temperature range where austenitizing of the metallic substrate takes place, allowing further hardening by quenching.

Steel press hardened parts intended for the manufacture of automobiles can be deep drawn at high temperatures and are quenched in the forming tools to reach the targeted microstructure. In terms of material properties, tensile strength from 500 to 2000 MPa and tensile elongation from 5 to 15% can be achieved.

Hardened parts can be coated with zinc-based coating or aluminum-based coating.

Zinc-based coatings are generally used because they allow protection against corrosion thanks to barrier protection and cathodic protection.

However, when forming at high temperatures such zinc coated steel sheets, external oxide containing zinc becomes peeled off the sheet being formed. An oxide powder is thus generated and aggregated. After a certain number of stamped parts, the forming tools have to be wiped and cleaned to remove the aggregated powder. This powdering requires the press-hardening line to be stopped and results in a loss of productivity. If not removed from the forming tools, the fouling from the aggregated powder would eventually cause the steel sheet to teer down or the stamping tool breaking, resulting in a much longer line shutdown.

Aluminum-based coatings have a good aptitude for press hardening at high temperatures and for painting. They allow for a protection by barrier effect. However, they do not allow for a cathodic protection.

The patent EP3239336 is directed to providing a press hardened part, which can minimize the problem that a plated layer is detached from a plating object and attached to the surface of a mold during hot press forming. However, the coating disclosed does not provide cathodic protection.

It is an object of the present invention to provide a coated steel sheet providing cathodic protection and suitable for manufacturing a press hardened part with good powdering resistance during press-hardening and good corrosion performance.

The present invention provides a steel sheet, wherein said metallic coating comprises, by weight percent, from 7.5 to 9.0% of zinc, from 2.0 to 4.0% of silicon, from 1.1 to 4.0% of magnesium, up to 3.0% of iron, optional elements chosen from Pb, Ni, Zr, or Hf, the content by weight of each element being less than 0.3%, optionally up to 100 ppm of calcium, and unavoidable impurities up to 0.02%, the balance being aluminum, and wherein the coating weight of said metallic coating for the sum of both sides of said steel sheet is from 50 to 500 g/m².

The present invention provides a method for the manufacture of a hardened part coated with an anti-corrosion coating comprising the following steps:
A) the provision of a coated steel sheet as described above,
B) the cutting of the coated steel sheet to obtain a blank,
C) the thermal treatment of the blank at a temperature from 840 to 950° C. to obtain a fully austenitic microstructure in the steel,
D) the transfer of the blank into a press tool,
E) the press-hardening of the blank to obtain a part, and
F) the cooling of the part obtained at step E) in order to obtain a press-hardened coated steel part.

The present invention also provides a press hardened coated steel part obtained by press-hardening of a coated steel sheet as described above, having an oxide layer on its external surface, wherein the amount of magnesium oxides particles with a diameter above 5 μm is above 100 particles/mm².

The present invention also provides the use of a press hardened coated steel part as described above, for the manufacture of an automotive vehicle.

### BRIEF DESCRIPTION OF THE DRAWINGS

To illustrate the present invention, various embodiments and trials of non-limiting examples will be described, particularly with reference to the following figures:

FIG. 1 illustrates the uniform layer structure observed by cross-section of the metallic coating after heat-treatment on a 1.5 mm thick steel sheet with a coating comprising 8% by weight of zinc (trial 2), according to the present invention.

FIG. 2 illustrates the non-uniform layer structure observed by cross-section of the metallic coating after heat-treatment on a 0.8 mm thick steel sheet, with a coating comprising 15% by weight of zinc (trial 4), not according to the invention.

FIG. 3 illustrates the distribution of magnesium oxide (MgO) particles having a size of 5 μm or more after hardening, on the surface of a metallic coating comprising 15% by weight of zinc, not according to the invention. MgO particles show as black circular areas.

FIG. 4 illustrates the distribution of MgO particles having a size of 5 μm or more after hardening, on the surface of a metallic coating comprising 8% by weight of zinc, according to the invention.

FIG. 5 shows a part having a linear profile and a cross-section in a “hat shape”, such part has been tested in the examples of the present disclosure.

### DETAILED DESCRIPTION

The present invention provides for a steel sheet coated with a metallic coating comprising by weight percent, from 7.5 to 9.0% of zinc, from 2.0 to 4.0% of silicon, from 1.1 to 4.0% of magnesium, up to 3.0% of iron as residual element, and unavoidable impurities up to 0.02%, the balance being aluminum.

Preferably, the coating comprises, in weight percent, from 1.5 to 2.5% of magnesium.

Optionally, the coating comprises additional elements chosen from Ni, Zr, Hf, Sr, Sb, Pb, Ti, Ca, Mn, Sn, La, Ce, Cr, or Bi, the content by weight of each additional element being inferior to 0.3 wt. %.

In a preferred embodiment, up to 100 ppm in weight of calcium is added.

Finally, the coating may contain unavoidable impurities up to 0.01 wt. %.

The steel sheet according to the present invention can be manufactured by hot dip galvanizing in a bath, the temperature of which is set from 600 to 700° C., preferably from 620 to 650° C.

The coating weight is set during the wiping process by gas knives in a range from 50 to 500 g/m², possibly from 80 to 150 g/m² and preferably from 100 and 120 g/m² for the sum of both sides of the steel sheet.

Before being coated, the steel sheet according to the invention can be obtained by hot rolling and optionally cold rolling depending on the desired thickness, which can be for example between 0.5 and 3.0 mm.

The steel substrate to be coated can have any composition, depending on the final properties required. When the steel is used for press-hardening, its composition is preferably as described below.

This method according to the invention comprises the following steps:
A) the provision of a steel sheet according to the invention,
B) the cutting of the coated steel sheet to obtain a blank,
C) the thermal treatment of the blank at a temperature between 840 and 950° C. to obtain a fully austenitic microstructure in the steel,
D) the transfer of the blank into a press tool,
E) the press hardening of the blank to obtain a part, and
F) the cooling of the part obtained at step E) in order to obtain a press hardened coated steel sheet.

Other characteristics and advantages of the invention will become apparent from the following detailed description of the invention.

In step A, any steel can be advantageously used in the frame of the invention as long as it is coated with a metallic coating comprising, in weight percent, from 7.5 to 9.0% of zinc, from 2.0 to 4.0% of silicon, from 1.1 to 4.0% of magnesium, up to 3.0% of iron, optional elements chosen from Pb, Ni, Zr, or Hf, the content by weight of each element being less than 0.3%, optionally up to 100 ppm of calcium and unavoidable impurities up to 0.02%, the balance being aluminum.

However, in case steel having high mechanical strength is needed, in particular for parts of structure of automotive vehicle, steel having a tensile resistance superior to 500 MPa, advantageously between 500 and 2000 MPa before or after heat-treatment, can be used. The weight composition of steel sheet is preferably as follows: 0.03%≤C≤0.50%; 0.3%≤Mn≤3.0%; 0.05%≤Si≤0.8%; 0.015%≤Ti≤0.2%; 0.005%≤Al≤0.1%; 0%≤Cr≤2.50%; 0%≤S≤0.05%; 0% ≤P≤0.1%; 0%≤B≤0.010%; 0%≤Ni≤2.5%; 0%≤Mo≤0.7%; 0%≤Nb≤0.15%; 0%≤N≤0.015%; 0%≤Cu≤0.15%; 0%≤Ca≤0.01%; 0%≤W≤0.35%, the balance being iron and unavoidable impurities from the manufacture of steel.

For example, the steel sheet is 22MnB5 with the following weight composition: 0.20%≤C≤0.25%; 0.15%≤Si≤0.35%; 1.10%≤Mn≤1.40%; 0%≤Cr≤0.30%; 0.020%≤Ti≤0.060%; 0.020%≤Al≤0.060%; 0.002%≤B≤0.004%, the remainder being iron and unavoidable impurities from the manufacture of steel.

In another embodiment, the steel sheet has the following weight composition: 0.24%≤C≤0.38%; 0.40%≤Mn≤3%; 0.10%≤Si≤0.70%; 0.015%≤Al≤0.070%; Cr≤2%; 0.25%≤Ni≤2%; 0.015%≤Ti≤0.10%; Nb≤0.060%; 0.0005%≤B≤0.0040%; the remainder being iron and unavoidable impurities resulting from the manufacture of steel.

Alternatively, the steel sheet can have the following weight composition: 0.30%≤C≤0.40%; 0.5%≤Mn≤1.0%; 0.40%≤Si≤0.80%; 0.1%≤Cr≤0.4%; 0.1%≤Mo≤0.5%; 0.01%≤Nb≤0.1%; 0.01%≤Al≤0.1%; 0.008%≤Ti≤0.003%; 0.0005%≤B≤0.003%; 0.0%≤P≤0.02%; 0.0%≤Ca≤0.001%; 0.0%≤S≤0.004%; 0.0%≤N≤0.005%, the remainder being iron and unavoidable impurities resulting from the manufacture of steel.

In another embodiment, the steel sheet has the following weight composition: 0.040%≤C≤0.100%; 0.80%≤Mn≤2.00%; 0%≤Si≤0.30%; 0%≤S≤0.005%; 0%≤P≤0.030%; 0.010%≤Al≤0.070%; 0.015%≤Nb≤0.100%; 0.030%≤Ti≤0.080%; 0%≤N≤0.009%; 0%≤Cu≤0.100%; 0%≤Ni≤0.100%; 0%≤Cr≤0.100%; 0%≤Mo≤0.100%, the balance being iron and unavoidable impurities from the manufacture of steel.

In another embodiment, the steel sheet has the following weight composition: 0.06%≤C≤0.1%, 1%≤Mn≤2%, Si≤0.5%, Al≤0.1%, 0.02%≤Cr≤0.1%, 0.02% ≤Nb≤0.1%, 0.0003%≤B≤0.01%, N≤0.01%, S≤0.003%, P≤0.020% less than 0.1% of Cu, Ni and Mo, the remainder being iron and unavoidable impurities resulting from the manufacture of steel.

In another embodiment, the steel sheet has the following weight composition: 0.015%≤C≤0.25%; 0.5%≤Mn≤1.8%; 0.1%≤Si≤1.25%; 0.01%≤Al≤0.1%; 0.1%≤Cr≤1.0%; 0.01%≤Ti≤0.1%; 0%≤S≤0.01%; 0.001%≤B≤0.004%; 0% ≤P≤0.020%; 0%≤N≤0.01%; the balance being iron and unavoidable impurities from the manufacture of steel.

Alternatively, the steel sheet has the following weight composition: 0.2%≤C ≤0.34%; 0.5%≤Mn≤1.24%; 0.5%≤Si≤2.0%; 0%≤S≤0.01%; 0%≤P≤0.020%; 0%≤N≤0.01%, the balance being iron and unavoidable impurities from the manufacture of steel.

The steel sheet is cut into a blank in step B. Said coated steel blank may have a thickness which is not uniform. This is the case of the so-called “tailored rolled blanks” which are obtained from cutting a sheet obtained by a process of rolling with an effort which is variable along the direction of the length of the sheet. Or this may be also the case of the so-called “tailored welded blanks” obtained by the welding of at least two sub-blanks of different thicknesses.

In step C, a heat treatment of the blank is performed at a temperature from 800 to 970° C., preferably 840 to 950° C. Said blank is maintained during a dwell time from 1 to 15 minutes to have a full austenitic structure. During the heat treatment, the coating forms an alloy layer having a high resistance to corrosion and abrasion.

In step D, after the heat treatment, the blank is then transferred to a press-hardening tool.

In step E, the press-hardening takes place at a temperature from 600 to 830° C.

In step F, the part is cooled in the hot-forming tool or after the transfer to a specific cooling tool. The cooling rate is controlled depending on the steel composition, in such a way that the final microstructure after press hardening is consistent with the targeted mechanical properties. After press hardening, the part can be tempered to reach the target microstructure and mechanical properties.

In a preferred embodiment, the steel microstructure comprises, in terms of volume fraction, at least 95% of martensite.

In another embodiment, the steel microstructure comprises after press hardening, in terms of volume fraction, at least 50% of martensite and less than 40% of bainite.

In another embodiment, the steel microstructure comprises after press hardening, in terms of volume fraction, from 5 to 20% of martensite, up to 10% of bainite and at least 75% of equiaxed ferrite.

The part obtained in step F is topped by a superficial oxide layer on its outer surface. This oxide layer comprises aluminum, zinc and magnesium from the coating and iron from the steel substrate. Iron has diffused through the coating during heat treatment.

A coated part according to the invention is thus obtained by press hardening but is also achievable by any suitable combination of cold-stamping and press hardening.

When the hardened part leaves the stamping tools at the end of step F, some powder scratched from the external oxide layer of the coating may remain on the tools. Because of the forming at high temperature the formability is increased and spring-back out of the stamping tools is reduced. However, the press hardening process may be limited by the coating peel off. When the powdering weight of the surface of the press hardened part is above 0.9 g/m², the powdering of the coating generates excessive stamping tool wear and may induce line stops.

Regarding the coated part obtained in step F, the inventors have conducted several tests showing the influence of zinc content in the metallic coating.

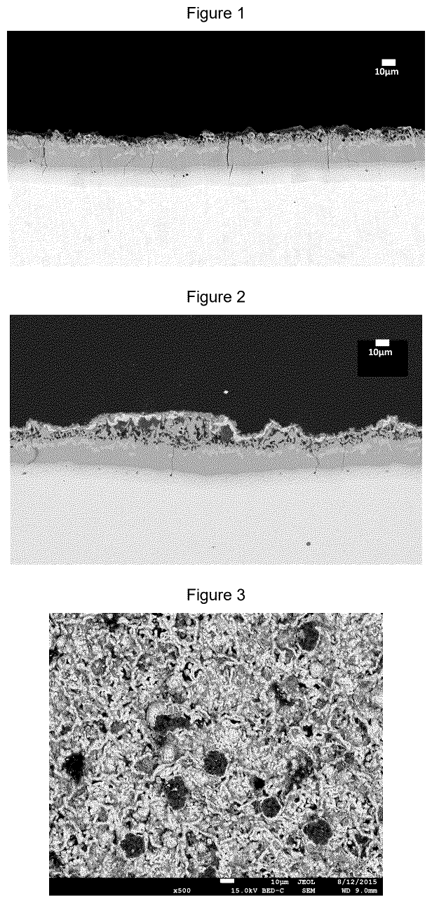

It has been observed that if the coating contains too much zinc, the surface becomes rough and the layer structure becomes non-uniform as can be seen on FIG. 2 compared to FIG. 1. It is believed that this contributes to poor powdering resistance.

During the heat treatment, the most oxidizable elements form oxides on the surface. This is the case of magnesium or calcium. Magnesium oxides are very hard particles compared to the surrounding zinc oxide phase. It is believed that hard MgO particles having a certain size may embrittle the external oxide layer and thus generate powdering.

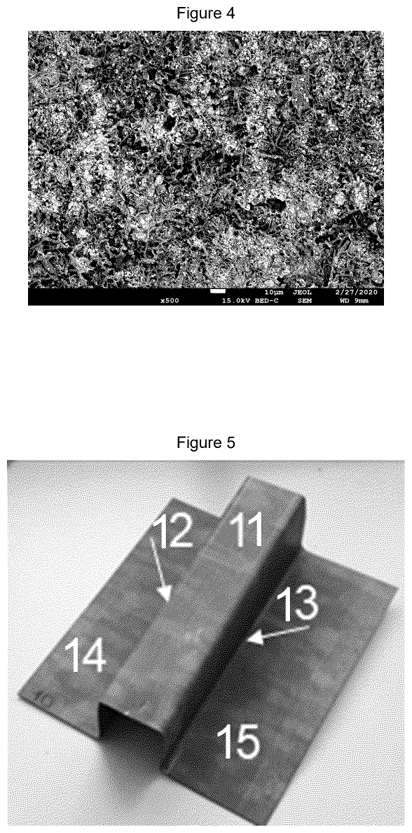

The inventors have surprisingly found that the surface density of MgO particles is linked with the amount of zinc in the coating. If there is too much zinc in the coating, the surface density of MgO particles with a diameter of 5 μm or more is above 100 particles/mm² as shown in FIG. 4.

If there is less than 5% by weight of zinc in the coating, the corrosion protection is not sufficient.

If there is more than 8% by weight of magnesium in the coating, the surface density of MgO particles with a diameter of 5 μm or more is above 100 particles/mm².

If there is less than 1.1% by weight of magnesium in the coating, other in use properties, such as corrosion resistance, are not achieved.

The invention will now be illustrated by tests as an indication and not as a limitation.

### EXAMPLES

For all samples, steel sheets used are 22MnB5. The composition of the steel is as follows: C=0.23%; Mn=1.2%; Si=0.25%; %; Cr=0.2%; Al=0.04%; Ti=0.04%; B=0.003%.

All coatings were deposited by hot-dip galvanization process. Hot dip bath temperature was set at 620 or 650° C.

The coated steel sheets were then cut to blanks and heat treated in a furnace at 900° C. for 5 to 6 minutes, depending on the steel sheet thickness. The sampling is presented in table 1.

The heated blanks were then transferred and quenched in tool die to obtain a microstructure containing at least 75% martensite in terms of surface fraction.

### Morphology of the Outside Surface and MgO Particles

To characterize the morphology of the oxide layer on the surface of the press-hardened parts, the surface has been observed thanks to Field Electron Gun—Scanning Electron Microscope with a of magnification ×500.

Energy Dispertion Spectroscopy (EDS) was then used to distinguish the presence of different elements on the picture, especially magnesium. Several EDS images were generated to cover an area of 0.14 mm² for each trial. With the image representing the element magnesium, a software for image analysis has been used on these images to determine small MgO particles of 5 μm diameter or more. Then said MgO particles were manually or automatically counted. Their surface density is disclosed in table 1.

### Laboratory Test to Evaluate Oxide Adherence and Powdering

For this experiment, the steel sheets were cut into rectangular blanks having the following dimension: 400×500 mm² before heat treatment.

After heating, each blank was transferred into a forming tool composed of a punch and a die of complementary shape. The tool has no additional binder to hold the blank during forming. The punch and the die were cooled with circulating water. Temperature set point of the cooled water circuit was 17° C.

The resulting part has a linear profile and a cross-section in a “hat” shape. Said section is made of five segments. FIG. 3 gives an indication of the different zones of said part, along its hat-shaped section: the “top of the hat” 11, two walls 12 and 13, and two bottom flanges 14 and 15 as shown in FIG. 5.

After press hardening, a portion is cut out of the part on the top of the “hat”. Coating powdering will then be assessed by measuring powdering weight on the “top of the hat” 11. The scale for weighting operations is from manufacturer Sartorius and its precision is 0.1 mg.

Adhesive tape 2525 from supplier 3M was cut to 50 mm×50 mm coupons, and a location of same size is marked on the sample for the test.

For all samples, the following procedure has been performed:
a) The adhesive coupon is weighted on laboratory balance,
b) The adhesive coupon is stitched to the sample on the defined location,
c) The adhesive coupon is removed from the sample and weighed again.
   If the weight difference is more than 0.1 mg, the procedure is restarted from step a) with a new coupon at the same location of the sample,
   If the weight difference is less than 0.1 mg, all measurable powder has been collected
d) The sum of weight differences (after-before stitching) is computed and divided by the area of the adhesive coupon (0.00025 m²) in order to get the weight of the powdering in g/m²

The results are gathered in table 1.

TABLE 1

| | | | | | | Sum of | Coating | Heat Treatment | | | Surfacial |
|---|---|---|---|---|---|---|---|---|---|---|---|
| | Sheet | | | | | coating | Bath | Parameters | | | density of |
| | Thick- | Coating composition | | | | weight for | Temper- | | Dwell | Powdering | MgO particles |
| Trial | ness | (weight %) | | | | both sides | ature | Furnace | Time | weight | Ø ≥ 5 μm |
| Nr | (mm) | Zn | Si | Mg | Al | (g/m2) | (° C.) | T (° C.) | (min) | (g/m²) | (particles/mm²) |
| 1* | 1.2 | 5.0 | 3.2 | 2.0 | balance | 120 | 650 | 900 | 6 | 0.117 | 21 |
| 2* | 1.5 | 8.0 | 3.2 | 2.0 | balance | 120 | 620 | 900 | 6 | 0.521 | 68 |
| 3* | 1.5 | 8.0 | 3.2 | 2.0 | balance | 150 | 620 | 900 | 6 | 0.863 | 76 |
| 4 | 0.8 | 15.0 | 3.0 | 2.0 | balance | 120 | 650 | 900 | 5 | 1.000 | 111 |
| 5 | 1.5 | 20.0 | 2.0 | 2.0 | balance | 150 | 650 | 900 | 6 | 2.186 | 189 |
| 6 | 1.5 | 30.0 | 2.0 | 2.0 | balance | 150 | 650 | 900 | 6 | 1.688 | 326 |

*Trials according to the invention, underlined values are not according to the invention

1-9. (canceled)

10. A coated steel sheet comprising:
a metallic coating and a steel sheet coated with the metallic coating, the metallic coating comprising, by weight percent:
from 7.5 to 9.0% of zinc;
from 2.0 to 4.0% of silicon;
from 1.1 to 4.0% of magnesium;
up to 3.0% of iron;
optional elements chosen from Pb, Ni, Zr, or Hf, the content by weight of each element being less than 0.3%, and
optionally up to 100 ppm of calcium, and unavoidable impurities up to 0.02%, a balance being aluminum, and
wherein a coating weight of the metallic coating is from 50 to 500 g/m² for the sum of both sides of the steel sheet.

11. The steel sheet according to claim 10 wherein the coating weight of the coating is from 80 to 150 g/m² for the sum of both sides of the steel sheet.

12. A method for the manufacture of a hardened part coated with an anti-corrosion coating comprising the following steps:
A) providing the coated steel sheet as recited in claim 10;
B) cutting the coated steel sheet to obtain a blank;
C) thermally treating the blank at a temperature from 840 to 950° C. to obtain a fully austenitic microstructure in the steel sheet;
D) transferring the blank into a press tool;
E) press hardening the blank to obtain a part,
F) cooling of the part to obtain a press-hardened coated steel part.

13. A press hardened coated steel part obtained by press-hardening of the coated steel sheet as recited in claim 10, the coating having an oxide layer on an external surface, wherein an amount of magnesium oxides particles with a diameter above 5 μm is above 100 particles/mm².

14. The press hardened coated steel part according to claim 13 wherein the microstructure includes, in terms of volume fraction, at least 95% of martensite.

15. The press hardened coated steel part according to claim 13 wherein the microstructure includes in terms of volume fraction, at least 50% of martensite and less than 40% of bainite.

16. The press hardened coated steel part according to claim 13 wherein the microstructure includes, in terms of volume fraction, from 5 to 20% of martensite, up to 10% of bainite and at least 75% of equiaxed ferrite.

17. The press hardened coated steel part according to claim 13 wherein the coating has a powder resistance such that an amount of metallic powder resulting from peeling off the metallic coating, measured by weighting an adhesive tape torn off from the surface of the part, is less than 0.9 g/m².

18. A method for manufacturing a press hardened coated steel part of an automotive vehicle comprising employing the coated steel sheet as recited in claim 13.
